(19) United States
(12) Patent Application Publication
(10) Pub. No.: US 2016/0104129 A1
(43) Pub. Date: Apr. 14, 2016

(54) ARTIFICIAL INTELLIGENCE RESEARCH TOOL

(71) Applicant: BANK OF AMERICA CORPORATION, CHARLOTTE, NC (US)

(72) Inventors: Timothy Satyanand Sadarla, Mandavalli (IN); Gautam Ravi, Hyderabad (IN); Tarundeep Singh, Secunderabad (IN)

(21) Appl. No.: 14/510,871

(22) Filed: Oct. 9, 2014

(51) Int. Cl. G06Q 20/04; G06N 5/02

(52) U.S. Cl. CPC G06Q 20/042; G06N 5/02

(57) ABSTRACT

The present invention is directed to a software-based system that enables an associate (a researcher, an adjuster, an agent, a customer service specialist, a teller, or the like) of a financial institution to quickly and accurately research and resolve particular error cases, such as encoding or listing errors of monetary amounts of recent transactions. To resolve these error cases, the associate may utilize the system of the present invention to aid with researching and inputting information about the error case. The system of the present invention further provides a standardized set of procedures for resolving the error case based on the determined error type of the error case. The system of the present invention ensures efficiency and accuracy of error case processing and resolution.

### BACKGROUND

When a check is processed by a financial institution, one or more errors may be identified. For example, a check amount may have been entered incorrectly into the financial institution's check processing system. To correct the identified errors, an associate of the financial institution is typically tasked with researching information associated with the check, as well as any corresponding transaction in which the check was used as tender. However, current research methods are subjective based on the person tasked with researching the error, potentially negatively affecting accuracy and efficiency of information collected during research, which is required for resolution of the identified errors. Therefore, a need exists for a research tool that enables an associate of a financial institution to accurately and efficiently research and resolve identified errors.

### BRIEF SUMMARY

The present invention is directed to a software-based system that enables an associate (a researcher, an adjuster, an agent, a customer service specialist, a teller, or the like) of a financial institution to quickly and accurately research and resolve particular error cases, such as encoding or listing errors of monetary amounts of recent transactions. For example, an encoding error occurs when an account holder of the financial institution attempts to deposit into an account a check that is valid for $1000, but the deposited check is recognized by the financial institution (or check imaging software of an automated teller machine (ATM), for example) as being valid for only $100. Conversely, a listing error occurs when an amount that has been credited and/or debited to an account is incorrectly listed on cash letters. Other errors may include duplicate transactions involving a check or a check deposit. To resolve these error cases, the associate may utilize the system of the present invention to aid with researching and inputting information about the error case. The system of the present invention then determines and provides a research scenario for resolving the error case based on the determined error type and creates case notes after the associate has finished researching the error case. Moreover, the system may also populate forms or other interfaces for communicating the errors for resolution. This ensures efficiency and accuracy of error case resolution.

In some embodiments, a system for resolving error cases related to transactions using a research tool that provides a research scenario from a plurality of research scenarios based on information related to an error case for a transaction is provided. The system comprises: at least one memory; at least one processor; and at least one module stored in memory, executable by the at least one processor, and configured for: presenting a research interface to a user to resolve the error case related to the transaction for which an error occurred during processing of the transaction; receiving error case information associated with the error case, wherein the error case information may be inputted manually or populated automatically with information captured during processing of the transaction, and wherein the error case information comprises a plurality of inputs about the error; initiating presentation of the research scenario from the plurality of research scenarios comprising a plurality of resolution information fields configured for receiving resolution information of the error case, wherein the research scenario presented is based on combinations of the plurality of inputs about the error; receiving resolution information for the error case, wherein the resolution information is inputted into the plurality of resolution information fields from the user; and generating case notes for resolving the error case based on the error case information and the resolution information received for the error case.

In some embodiments, initiating presentation of the research scenario comprises determining a scenario number based on the error case information, wherein the scenario number corresponds to the research scenario from the plurality of research scenarios.

In some embodiments, the research scenario further comprises predetermined instructions for researching the error case, wherein the predetermined instructions further comprise research steps for researching and resolving the error case and checkpoints for making sure the use is following the research steps.

In some embodiments, the module stored is further executable by the at least one processor, and configured for generating a form from a plurality of forms with at least one of the error case information, the resolution information, or the case notes of the error case for communication with a processing entity from a plurality of processing entities for resolution of the error case, wherein the form and processing entity are selected by the user.

In some embodiments, the module stored is further executable by the at least one processor, and configured for transmitting the form to the processing entity for resolution of the error case, wherein resolution of the error case comprises an adjustment of at least one financial account balance.

In some embodiments, the module stored is further executable by the at least one processor, and configured for: generating a resolution history of each error case resolved by the user after generating the case notes.

In some embodiments, the error case information comprises an input indicating that the error case is a debit case or a credit case, an input indicating that the error case is an internal account or an external account, and an input indicating that adjustment funds has or has not already been applied to an account.

In some embodiments, receiving error case information of the error case comprises calculating the case amount based on a calculated difference between the listed transaction amount and the correct transaction amount.

In some embodiments, the error case information is automatically received from a transaction processing application that comprises information related the error case including at least one of account information, payment information, and transaction information.

In some embodiments, the resolution information comprises at least one of a maker account number, a maker name, a depositor name, a depositor account number, a reversal of charges, a customer initiated case, a government restriction, or an outgoing bank name.

In some embodiments, a computer program product for resolving error cases related to transactions using a research tool that provides a research scenario from a plurality a research scenarios based on information related to an error case for a transaction is provided. The computer program product comprises at least one non-transitory computer-readable medium having computer-readable program code portions embodied therein. The computer-readable program code portions comprise: an executable portion configured for presenting a research interface to a user to resolve the error case related to the transaction for which an error occurred during processing of the transaction; an executable portion configured for receiving error case information associated with the error case, wherein the error case information may be inputted manually or populated automatically with information captured during processing of the transaction, and wherein the error case information comprises a plurality of inputs about the error; an executable portion configured for initiating presentation of the research scenario from the plurality of research scenarios comprising a plurality of resolution information fields configured for receiving resolution information of the error case, wherein the research scenario presented is based on combinations of the plurality of inputs about the error; an executable portion configured for receiving resolution information for the error case, wherein the resolution information is inputted into the plurality of resolution information fields from the user; and an executable portion configured for generating case notes for resolving the error case based on the error case information and the resolution information received for the error case.

In some embodiments, the executable portion configured for initiating presentation of the research scenario comprises: determining a scenario number based on the error case information, wherein the scenario number corresponds to the research scenario from the plurality of research scenarios.

In some embodiments, the research scenario further comprises predetermined instructions for researching the error case, wherein the predetermined instructions further comprise research steps for researching and resolving the error case and checkpoints for making sure the user is following the research steps.

In some embodiments, the computer-readable program code portions further comprise an executable portion configured for generating a form from a plurality of forms with at least one of the error case information, the resolution information, or the case notes of the error case for communication with a processing entity from a plurality of processing entities for resolution of the error case, wherein the form and processing entity are selected by the user.

In some embodiments, the computer-readable program code portions further comprise an executable portion configured for transmitting the form to the processing entity for resolution of the error case, wherein resolution of the error case comprises an adjustment of at least one financial account balance.

In some embodiments, the computer-readable program code portions further comprise an executable portion configured for generating a resolution history of each error case resolved by the user after generating the case notes.

In some embodiments, the error case information comprises an input indicating that the error case is a debit case or a credit case, an input indicating that the error case is an internal account or an external account, and an input indicating that an adjustment funds has or has not already been applied to an account.

In some embodiments, the executable portion configured for receiving error case information of the error case comprises calculating the case amount based on a calculated difference between the listed transaction amount and the correct transaction amount.

In some embodiments, the error case information is automatically received from a transaction processing application that comprises information related the error case including at least one of account information, payment information, and transaction information.

In some embodiments, the resolution information comprises at least one of a maker account number, a maker name, a depositor name, a depositor account number, a reversal of charges, a customer initiated case, a government restriction, or an outgoing bank name.

In some embodiments, a method for resolving error cases related to transactions using a research tool that provides a research scenario from a plurality a research scenarios based on information related to an error case for a transaction is provided. The method comprises: presenting a research interface to a user to resolve the error case related to the transaction for which an error occurred during processing of the transaction; receiving error case information associated with the error case, wherein the error case information may be inputted manually or populated automatically with information captured during processing of the transaction, and wherein the error case information comprises a plurality of inputs about the error; initiating presentation of the research scenario from the plurality of research scenarios comprising a plurality of resolution information fields configured for receiving resolution information of the error case, wherein the research scenario presented is based on combinations of the plurality of inputs about the error; receiving resolution information for the error case, wherein the resolution information is inputted into the plurality of resolution information fields by the user; and generating case notes for resolving the error case based on the error case information and the resolution information received for the error case.

The system of the present invention provides many benefits. First, the system of the present invention reduces the amount of time it takes to process and research information for resolving an error case, particularly in regards to eliminating duplication of inputted information. Second, by providing a research scenario based on a determined error type of the error case, the system of the invention increases accuracy of information collected during research. Third, generating a standardized set of procedures further reduces time spent resolving the error case and further ensures accuracy of information. Clearly, the system of the present invention saves associates of a financial institution a considerable amount of time when resolving error cases.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 is an exemplary process flow illustrating a process for resolving error cases related to transactions using a research tool that provides steps for resolving the error cases, in accordance with embodiments of the present invention;

FIG. 2 is an exemplary user interface for researching an error case, in accordance with embodiments of the present invention;

FIG. 3 is an exemplary user interface for populating a form for resolving an error case, in accordance with embodiments of the present invention; and

FIG. 4 is an exemplary system environment for resolving error cases related to transactions using a research tool that provides steps for resolving the error cases, in accordance with embodiments of the present invention.

### DETAILED DESCRIPTION OF THE PRESENT INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments, an “entity” may not be a financial institution.

As used herein, the term “user” refers to anyone who interacts with the present invention. Typically, the user is an associate (e.g., an employee, agent, contractor, or the like) of a financial institution (e.g., the entity) who is responsible for researching and/or resolving an error identified during processing of a transaction (e.g., check or another payment instrument) be it a paper instrument or electronic instrument. The user may be a researcher, a resolver, a customer service specialist, an adjustment specialist, a teller, or another type of associate.

The present invention is directed to a software-based system that enables a user, such as an associate of a financial institution to quickly and accurately research and resolve particular error cases, such as encoding or listing errors of monetary amounts of recent transactions. For example, during processing of a check or other payment instrument transaction (e.g., a credit card, a debit card, an electronic funds transfer, or another instrument used to facilitate a transfer of funds between two or more parties in a transaction), the system of the present invention is utilized by the user to research and/or resolve an identified error. In some embodiments, the system of the present invention is configured to help the user research and resolve errors of a particular error type (e.g., an encoding error type or a listing error type). In other embodiments, the system of the present invention is configured to help the user research and resolve a wide variety of other error types.

For example, an encoding error occurs when an account holder of the financial institution attempts to deposit into an account a check (or another payment instrument) that is valid for $1000, but the deposited check is recognized by the financial institution (or check imaging software of an automated teller machine (ATM), for example) as being valid for only $100 (or vice versa). Therefore, the check (or other payment instrument) has been ‘underencoded’ (or ‘overencoded’) during processing of the check (or other payment instrument). Conversely, a listing error occurs when an incorrect amount of funds is credited or debited to an account even through the value determined from the check is correct. Other errors may include duplicate transactions involving a check or a check deposit, a discrepancy of a check amount based on check image processing software, a missing transaction, or the like. To resolve these error cases, the associate may utilize the system of the present invention to aid with researching and inputting information about the error case. The system of the present invention then determines a research scenario for resolving the error case based on the determined error type and the information inputted by the user. Moreover, the system may also populate forms or other interfaces for communicating the errors for resolution. This ensures efficiency and accuracy of error case resolution.

The system of the present invention provides many benefits. First, the system of the present invention reduces the amount of time it takes to process and research information for resolving an error case, including eliminating duplication of inputted information. Second, by providing a research scenario based on information about the transaction and errors types associated with the transaction, the system of the present invention increases the accuracy of information collected during research. Third, generating case notes and/or populating communication forms or interfaces with information further reduces time spent resolving the error case and further ensures accuracy of information.

Clearly, the system of the present invention saves associates of a financial institution a considerable amount of time when resolving error cases. Based on the different types of errors that could occur in processing transactions, the present invention may have a potential of 100 (or more or less) scenarios for researching and resolving the errors associated with processing the transactions. It typically may take as little as 10 minutes up to 2 and ½ hours to research an error case depending on the type of error and the conditions that caused the error. As such, it is often difficult for an associate to identify the proper information, research the error case, and send out the proper resolution. The present invention provides an improved way to manage researching resolution of error cases, and thus reduces the time spent by associates resolving error cases by up to 35 to 45% (or more).

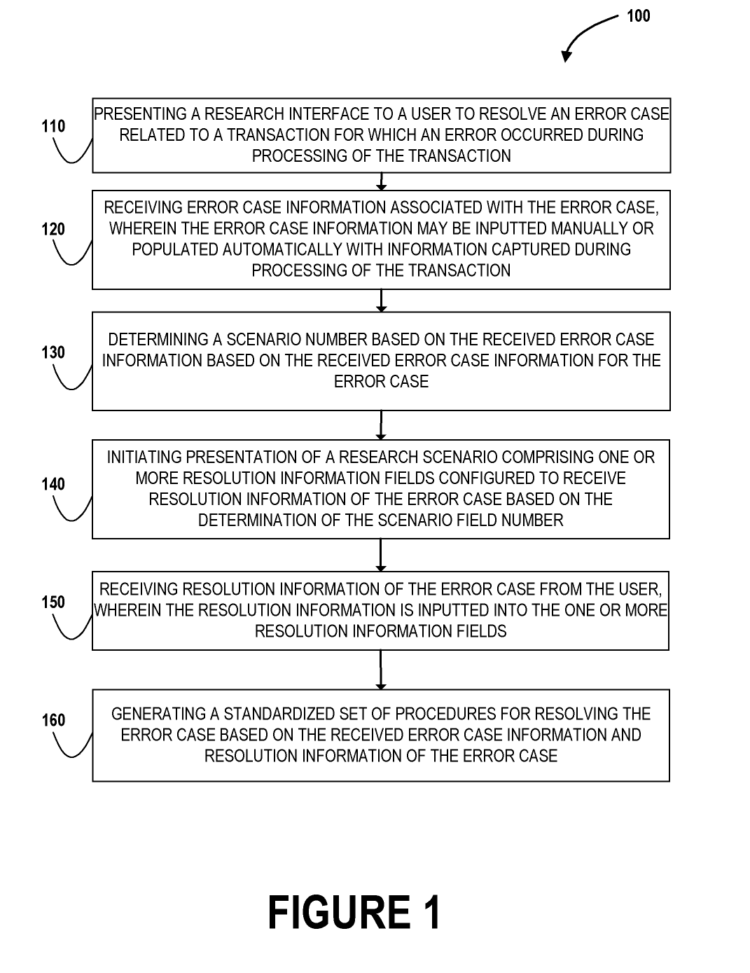

Referring now to the Figures, FIG. 1 is an exemplary process flow 100 for researching and resolving an error case. At block 110, the process includes presenting a research interface to a user to resolve an error case related to a transaction for which an error occurred during processing of the transaction. At block 120, the process includes receiving error case information associated with the error case, wherein the error case information may be inputted manually or populated automatically with information captured during processing of the transaction. At block 130, the process includes determining a scenario number based on the received error case information based on the received error case information for the error case, wherein the scenario number is associated with an error type. At block 140, the process includes initiating presentation of a research scenario based on the determination of the scenario number, wherein the research scenario comprises one or more resolution information fields configured to receive resolution information of the error case, a predetermined set of instructions 222, and a predetermined set of checkpoints 224. At block 150, the process includes receiving resolution information of the error case from the user, wherein the resolution information is inputted into the one or more resolution information fields. At block 160, the process includes generating a standardized set of case notes for resolving the error case based on the received error case information and resolution information of the error case.

The system of the present invention may be integrated with a transaction processing application that is configured to receive, store, and transmit account information (e.g., an account number, a routing number, a transaction history of an account held by a customer, profile information of the customer, a financial institution name, a source of receipt of a transaction, or the like), check information (e.g., a check number, a check amount, a check date, a payee, a recipient, an issuing financial institution, a receiving financial institution, or the like) or like payment information, error case information (e.g., information associated with an identified error such as a case number, a case amount, an error type, or the like), or the like. The transaction processing application is configured to generate, store, and analyze the above information (and additional information related to a transaction or a payment vehicle not mentioned above). The transaction processing application is therefore configured to identify one or more errors (e.g., error cases) associated with a transaction. In other embodiments of the invention, instead of the transaction processing application, any system or application therein (including the systems and applications of the present invention) may identify one or more errors in the same or similar way as the transaction processing application described herein. Moreover, in other embodiments of the invention the customer may notify the financial institution responsible for the one or more errors by calling associates (e.g., customer service representatives) at the financial institution or electronically notifying the financial institution (e.g., through an online banking application, or other system), and the financial institution enters the error into the transaction processing application or another system or application.

The transaction processing application may be further configured to determine an error type of each identified error. The transaction processing application may then, based on determination of error type of each identified error, generate one or more queues of errors for each error type or groups of error types. In other embodiments the queues of errors may be within the system of the present invention or in another system with which the system of the present invention communicates. In this way, the identified errors of each error type (as well as information associated with the identified errors) may be accessed by various systems or applications for processing, research, and resolution of the errors. As such, the system of the present invention may be configured to receive (e.g., be push or pull) one or more identified errors (e.g., error cases), as well as associated information, of one or more particular error types (such as encoding or listing error types) from the transaction processing application. The system of the present invention then utilizes the information from the transaction processing application to processes the identified errors for research and resolution of the error cases.

Additionally, upon identification of an error case, the transaction processing application or another transaction system may, in some embodiments, be configured to determine and assign a case number comprising one or more alphanumeric characters to the identified error case for identification purposes. In this way, the error may be referenced by the case number for efficient recall of information pertaining to the error case held in data storage of the transaction processing application (or stored in other locations). In other embodiments, the system of the present invention may be configured to determine and assign a case number to the identified error case.

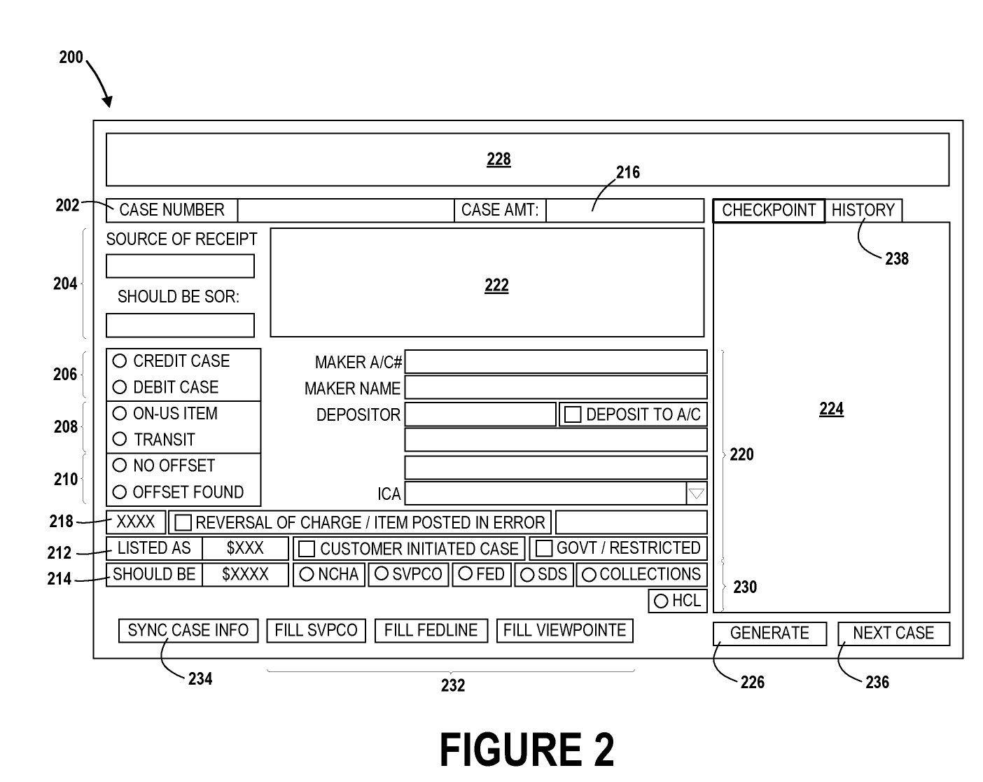

FIG. 2 depicts an exemplary research user interface 200 for researching and resolving an error case. Upon the system initiating presentation of the research interface 200 to the user, the user inputs error case information (e.g., details associated with the error case such as a time and date of a transaction, account information, or the like) associated with an identified error case stored in an error queue received from the transaction processing application or another application, or provided in other records (e.g., an account summary provided by a third party). For example, the user may input a case number 202 of the error case as specified in an error queue in a transaction processing application, therefore providing reference to the identified error case. Other fields of information included in the error case information and inputted by the user may include a source of receipt (SOR) 204 (e.g., a name of a financial institution or merchant that is indicated as the entity that generated or processed the transaction associated with the identified error case), or the user may input a ‘Should Be SOR’ (e.g., the name of the entity that should be listed as generating or processing the transaction). In other embodiments, the error information may further include the role that the SOR plays in the transaction, such as maker of a transaction, depositor of a transaction, payee, or the like). Further included in the error case information may be a selection of whether the error case involves a credit or a debit of funds 206 (e.g., is the error related to a credit received or a debit made). The error case information may further include a selection of whether the error case is due to a mistake made by the issuing financial institution (e.g., on-us item) or another institution (e.g., transit) 208. Additionally, the user may make a selection of whether an adjustment such as a credit or debit of an amount of funds has already been applied to an account in attempt to resolve the error case (e.g., offset) or not (e.g., no offset) 210. The user may also input a ‘Listed As’ amount (e.g., an amount of funds that was incorrectly determined, inputted, listed, and/or processed by the financial institution) 212 and a ‘Should Be’ amount 214 (e.g., a correct, original amount of funds that was written or printed on the check or other payment instrument). The system of the present invention is configured to, upon receipt of the ‘Listed As’ amount 212 and the ‘Should Be’ amount 214, calculate and display a case amount 216 (e.g., an amount of funds equal to the difference between the ‘Listed As’ amount and the ‘Should Be’ amount). Alternatively, the error case information illustrated in the research interface 200, as described herein, may be populated (e.g., from the transaction processing application) automatically upon the system initiating presentation of the research interface 200. In this way, information already captured and/or stored in the transaction processing application (or another system or application) may be received by the system of the present invention and populated in the research interface 200, thus eliminating the need for manual entry of at least some of the error information by the user.

Based on the received error case information (inputted by the user or automatically populated from the transaction processing application or other system or application), the system of the present invention is configured to determine a sequence or scenario number 218 (e.g., an alphanumerical character string). For example, an error case may have a specific scenario number 218 of XXXX (or other like character string with more or less characters), or a specific range of scenario numbers 218 that is based on the error information imputed into the research interface and/or the error types. As such, errors that have the same error type and same error information may have the same scenario. The system of the present invention further includes means for adding, deleting, or modifying scenario numbers and the associated research scenarios.

Each scenario number 218 (or a part or parts within the scenario number 218, such as a single character or multiple characters) may correspond to particular error information or groups of error information, such that the scenario number 218 is determined based on error information associated with the error cases. Moreover, the specific scenario numbers 218 are associated with specific research scenarios. In this way, a specific research scenario for researching and/or resolving a specific error will be different from another specific research scenario for researching and/or resolving another specific error. The research scenario comprises one or more resolution information fields 220, pre-determined instructions 222, and/or checkpoints 224, which are explained in further detail below. Utilizing and following the research scenario during the research process ensures that the user collects information in an accurate and efficient manner for each error. The system of the present invention further includes means for adding, deleting, or modifying the research scenario for researching and/or resolving each error type of error.

Upon determination of the scenario number 218, the system of the present invention displays the scenario number 218 on the research interface 200 as shown in FIG. 2. Additionally, one or more information fields 220 associated with the research scenario, which are configured to receive resolution information (e.g., information collected during research used for resolving the error case) of the error case, are displayed by the system of the present invention on the research interface 200. In accordance with the association described above, the resolution information fields 220 displayed to the user based on determination of a first scenario number 218 will be different than the information fields 220 displayed to the user based on determination of a different (i.e., second) scenario number 218. This is because different pieces of resolution information are required for resolution of different error cases depending on the error information received for each error.

Resolution information may include but is not limited a maker account number (e.g., an account number of a financial institution or an account number associated with an account held by a payee, or the like), a maker name (e.g., a financial institution, a payee, or the like), a depositor (e.g., a financial institution, recipient of the check or other transaction payment, or the like), a selection of whether a deposit is required to a financial institution or an account, a selection of whether a reversal of charge is necessary or if an item has been posted in error, a selection of whether the error case occurred on an interoffice clearance application internal to the financial institution, a selection of whether the error case was processed domestically or within a particular governing body's jurisdiction domestically, whether the error case was initiated by a customer who holds an account in which the error case occurred, or the like. Different pieces of resolution information may be required according to different determined scenario numbers 218, which also corresponds to a particular research scenario for researching and/or resolving specific error types. As such, the information fields 220 presented to the user on the research interface 200 will vary based on the determined scenario number 218 (which is determined based on the error information associated with the error). The scenario numbers 218 and research scenarios make the research process for specific errors leaner, prevents subjective researching on a user by user basis, and eliminates duplication of work between users.

The system of the present invention further generates and presents to the user on the research interface 200 a predetermined set of instructions 222 for researching resolution information necessary for resolving the error case. The predetermined set of instructions 222 is generated based on the system-generated scenario number 218 that corresponds to the determined scenario number 218. The predetermined set of instructions 222 guides the user throughout the research process and ensure that resolution information is collected accurately and efficiently.

The system of the present invention further generates and presents to the user on the research interface 200 a predetermined set of checkpoints 224 for resolving the error case. The predetermined set of checkpoints 224 is generated based on the system-generated scenario number 218. While the predetermined set of instructions 222 guides the user throughout the research process of collecting resolution information (e.g., for a particular step in the process), the predetermined set of checkpoints 224 may be utilized by the user to make sure the user is following the predetermined set of instructions 222 property. Typically the predetermined set of checkpoints 224 includes text of standardized procedural steps or information, so that it is clear to the user that they have properly performed the predetermined set of instructions 222.

The user then researches the error case, based on at least the predetermined set of instructions 222 and the predetermined set of checkpoints 224, to fill the information fields 220 with appropriate resolution information. Once the information fields 220 have been adequately filled with appropriate resolution information, the user may select a ‘Generate’ button 226 to generate case notes 228 for resolving the error case. The case notes 228 typically include a standardized set of procedures for resolving and/or closing the error case based on the received error case information and resolution information of the error case. For example, the case notes 228 may indicate if the error requires a requested credit or debit, to whom the request should be sent, the channel through which the request should be sent, or the like. In this way, the case notes 228 provide a textual history of the error case, error case information, resolution information, or the like, as well as information for resolving and/or closing the error case. Standardizing the case notes 228 enables a second user who is unfamiliar with the error case to quickly and easily identify important information related to resolution of the error case by viewing a resolution history tab 238. Generating the case notes 228 in a uniform format helps streamline communication between users. Once generated, the case notes 228 may be transmitted to a second user or a second apparatus for further processing and/or resolution of the error case.

In other embodiments of the invention, instead of utilizing scenario numbers 218 that are associated with research scenarios, the error information can be directly associated with the resolution fields 220, the predetermined instructions 222, and/or checkpoints 224 to determine what to display to the user based on the inputted error information. This can be achieved through a matrix, table, or other association means instead of a scenario number 218.

The system of the present invention also allows the user to select a processing entity 230 (e.g., clearing house entity or channel responsible for resolution of the error case, or the like) for transmittal of information related to the error case. The information related to the error case is transmitted to the selected processing entity 230 for finalization, processing, and/or resolution of the error case. In some embodiments, the processing entity 230 oversees the actual adjustment (e.g., transfer of funds) between two or more accounts, thus resolving the error case. In other embodiments the processing entity 230 is the intermediary between the parties. The processing entity 230 selections may include a National Clearing House Association (NCHA), a Small Value Payment Company (SVPCO), a Federal Reserve (FED), a Same Day Settlement (SDS) entity, a Holding Case Letter (HCL) entity, a Collections entity, or another adjustment-focused entity internal or external to the financial institution, or the like.

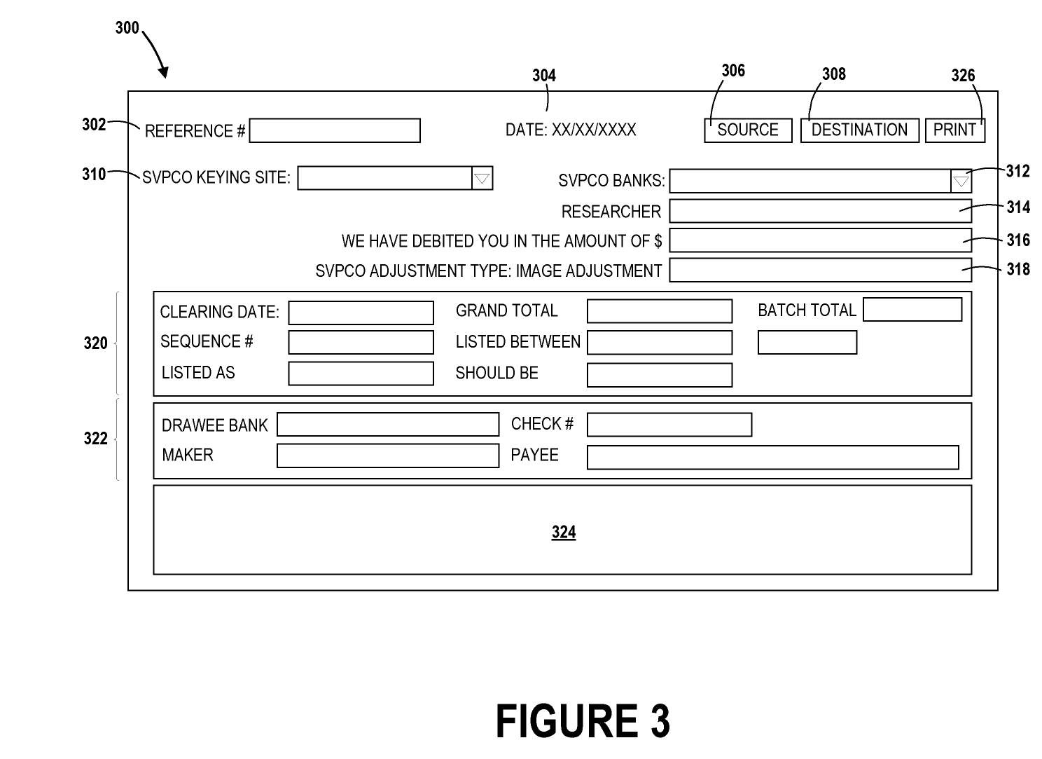

Upon selection of a processing entity 230, the user may select to fill a form 232 for communicating with the selected processing entity 230. Upon the user's selection to fill the form 232 for communicating with the selected processing entity 230, the system of the present invention initiates presentation of a form 232 (e.g., see form interface 300 in FIG. 3). The selected form 232 is populated with information (e.g., error case information, resolution information, case notes 228, or the like) received by the system of the present invention during research and/or processing of the error case. In this way, the system of the present invention provides a standardized form for communicating information about the error case (e.g., error case information, resolution information, or the like) to the processing entity 230 or multiple users, systems, or applications of the processing entity 230, for accurate and efficient resolution of the error case. Population of the standardized form with the error case information, resolution information, case notes 228, or the like prevents errors in transmitting the information regarding the resolution of the case to the processing entity 230.

The user is further enabled by the research interface 200 to sync case information (e.g., error case information, resolution information, or the like) with the transaction processing application or other similar system or application. In this way, the resolution information collected by the user during the research process (as well as error case information) will be stored within the transaction processing application or other similar system or application for later recall by the system of the present invention. Syncing the case information provides updated accuracy and consistency of information related to the error case throughout the financial institution and with other entities.

Next, the user may select the ‘Next Case’ button 234 to resolve and/or close the error case and receive a new error case. In some embodiments, the system of the present invention is configured to resolve the error case (e.g., execute necessary steps to adjust an amount of funds in an account, initiate transfer of funds between two or more accounts, or the like). In other embodiments, the system of the present invention may transmit the error case information, resolution information, case notes 228, and/or filled form 232 to a second apparatus or system for further processing and/or resolution of the error case. In this way, a second user may utilize the error case information, resolution information, and case notes 228 from the form to resolve the error case. For example, resolution of the error case may require validation or verification from a supervisor, manager, another entity, or the like.

Further, upon selection of the ‘Next Case’ button 234, the system of the present invention is configured to generate a resolution history 238 of the research and resolution processes. This resolution history 238 includes standardized textual documentation of the error case information, the resolution information, case notes 228, and/or the steps taken by the user when processing, researching, and/or resolving the error case. In this way, for example, the user (or a second user) may recall exactly what happened during the research process. The resolution history 238 may include a string of textual information for each error case researched and/or processed by the user which may be displayed in the resolution history 238 or may be accessed through a link displayed in the resolution history tab 238.

FIG. 3 depicts an exemplary form user interface 300 for generating a report (e.g., a form) for resolving an error case. Typically, when the user selects to fill the form 232 for communicating information to the selected processing entity 230 for resolution of the error case using the research interface 200 in FIG. 2, the system of the present invention is configured to initiate the presentation of the form interface 300 of FIG. 3. The form interface 300 is an exemplary form to be filled with error case information, resolution information, or the like based on the research process conducted in the research interface 200. The report of the form interface 300 provides standardized documentation of the error case and its research and/or resolution, and serves as a template for communicating with the selected processing entity 230 (or other entity responsible for resolving the error case). In some embodiments, the processing entities 230 may have different forms or the same form. Furthermore, in some embodiments all of the information is automatically populated into the form; however, in other embodiments only a portion of the form is automatically populated and at least a portion of the form is manually populated by the user.

In some embodiments, the system of the present invention is configured to populate the form interface 300 with error case information, resolution information, and case notes 228 upon initiating presentation of the form interface 300. For example, using the error case information, resolution information, case notes 228, and other information collected during the research process, the system of the present invention may populate the form interface 300 for communicating information to the SVPCO system for the purpose of resolving the error case. The SVPCO form (e.g., the form interface 300) may include sections for populating a reference number 302, a date of research 304, a source 306 (e.g., a sender name or account of an adjustment or amount of funds), a destination 308 (a recipient name or account of an adjustment or an amount of funds), a SVPCO keying site 310 (e.g., an office location in which a destination clearing house is located), a name of a SVPCO financial institution 312, a name of the user (or researcher) 314, an amount of funds to be debited to the destination 316 (or credited in other embodiments of the invention), an adjustment type 318, error case information 320, research information 322, or the like. Alternatively, the user may be required to input one or more of the above pieces of information into the form. For example, the user is enabled by the form interface 300 to input comments 324 into the form. In other embodiments, the form interface 300 includes different required pieces of information for communicating with different processing entities 230 or other entities, systems, or applications. Each filled form 232 and/or generated report for communicating with different processing entities 230 for resolution purposes may include a different standardized template.

After the form is appropriately filled with information, the system of the present invention may be configured to generate a standardized message according to a predetermined template including the above-mentioned information (e.g., the form or another report). For example, the form may generate an email including the error case information, resolution information, and/or case notes 228, as well as information related to the resolution of the error case found on the form. The template of the message and/or the filled form 232 described above may be determined based at least partially on the processing entity 230 selected by the user in the research interface 200. In some embodiments of the invention, the form, in and of itself, is the standardized message.

The system of the present invention may further be configured to transmit this form 232 (e.g., the report) and information (e.g., error case information, resolution information, case notes 228, information inputted into the form 232, or the like) to a second apparatus (e.g., internally or externally to a processing entity 230) for review, further processing of the information, or closing of the error case. For example, the form 232 is transmitted to a selected processing entity 230 for closing of the error case. Closing the error case in some embodiments includes transferring an amount of funds between two or more accounts as specified by the generated form 232 or report based on the received error case information resolution information, and/or case notes 228 so that the identified error case is resolved and any associated account balances are adjusted appropriately.

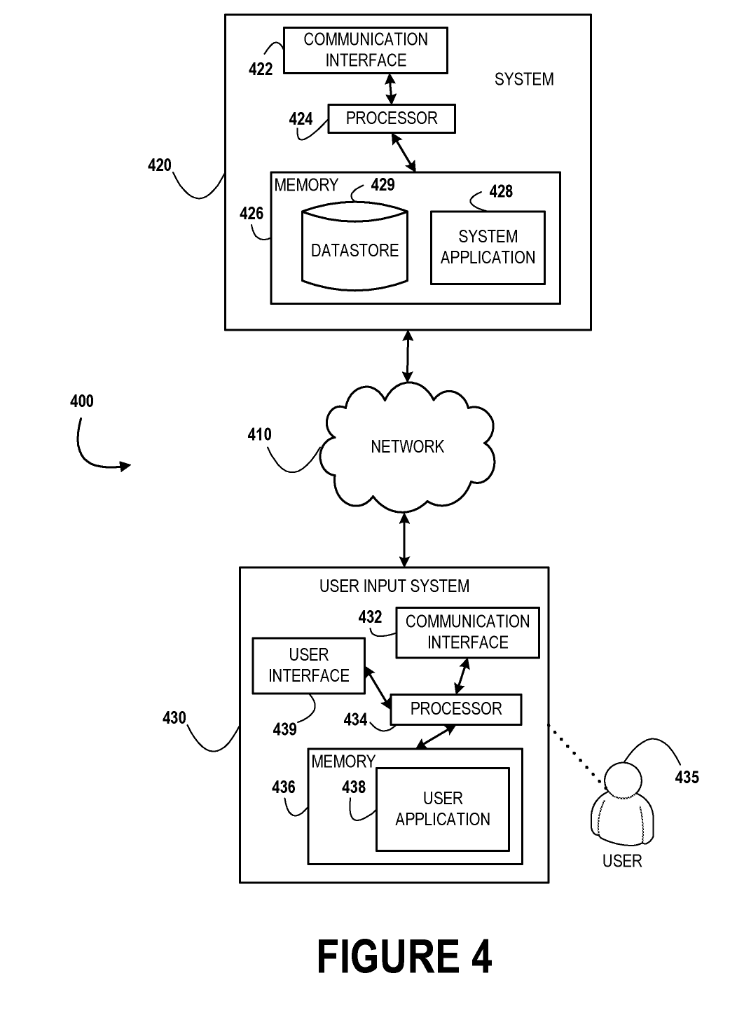

FIG. 4 is an exemplary block diagram illustrating technical components of a system 400 for implementing the system of the present invention for researching and resolving an error case as described in process flow 100 of FIG. 1, as well as the exemplary interfaces 200 and 300 as illustrated in FIGS. 2 and 3. As illustrated, the system environment 400 includes a network 410, a system 420, and a user input system 430.

As shown in FIG. 4, the system 420, and the user input system 430 are each operatively and selectively connected to the network 410, which may include one or more separate networks. In addition, the network 410 may include a telecommunication network, local area network (LAN), a wide area network (WAN), and/or a global area network (GAN), such as the Internet. It will also be understood that the network 410 is secure and may also include wireless and/or wireline and/or optical interconnection technology.

FIG. 4 also illustrates a system 420, in accordance with an embodiment of the present invention. The system 420 may refer to the “apparatus” described herein. The system 420 may include any computerized apparatus that can be configured to perform any one or more of the functions of the system 420 described and/or contemplated herein. In accordance with some embodiments, for example, the system 420 may include a computer network, an engine, a platform, a server, a database system, a front end system, a back end system, a personal computer system, and/or the like. Therefore, the system 420 may be a server managed by the entity. The system 420 may be located at the facility associated with the entity or remotely from the facility associated with the entity. In some embodiments, such as the one illustrated in FIG. 4, the system 420 includes a communication interface 422, a processor 424, and a memory 426, which includes a system application 428 and a datastore 429 stored therein. As shown, the communication interface 422 is operatively and selectively connected to the processor 424, which is operatively and selectively connected to the memory 426.

It will be understood that the system application 428 may be configured to implement any one or more portions of the various user interfaces and/or process flow described herein. The system application 428 may interact with the user application 438. It will also be understood that, in some embodiments, the memory includes other applications. It will also be understood that, in some embodiments, the system application 428 is configured to communicate with the datastore 429, the user input system 430, or the like.

It will be further understood that, in some embodiments, the system application 428 includes computer-executable program code portions for instructing the processor 424 to perform any one or more of the functions of the system application 428 described and/or contemplated herein. In some embodiments, the system application 428 may include and/or use one or more network and/or system communication protocols.

In addition to the system application 428, the memory 426 also includes the datastore 429. As used herein, the datastore 429 may be one or more distinct and/or remote datastores. In some embodiments, the datastore 429 is not located within the system and is instead located remotely from the system. In some embodiments, the datastore 429 stores information or data described herein.

It will be understood that the datastore 429 may include any one or more storage devices, including, but not limited to, datastores, databases, and/or any of the other storage devices typically associated with a computer system. It will also be understood that the datastore 429 may store information in any known way, such as, for example, by using one or more computer codes and/or languages, alphanumeric character strings, data sets, figures, tables, charts, links, documents, and/or the like. Further, in some embodiments, the datastore 429 may include information associated with one or more applications, such as, for example, the system application 428. It will also be understood that, in some embodiments, the datastore 429 provides a substantially real-time representation of the information stored therein, so that, for example, when the processor 424 accesses the datastore 429, the information stored therein is current or substantially current.

It will be understood that the embodiment of the system environment illustrated in FIG. 4 is exemplary and that other embodiments may vary. As another example, in some embodiments, the system 420 includes more, less, or different components. As another example, in some embodiments, some or all of the portions of the system environment 400 may be combined into a single portion. Likewise, in some embodiments, some or all of the portions of the system 420 may be separated into two or more distinct portions.

In addition, the various portions of the system environment 400 may be maintained for and/or by the same or separate parties. It will also be understood that the system 420 may include and/or implement any embodiment of the present invention described and/or contemplated herein. For example, in some embodiments, the system 420 is configured to implement any one or more of the embodiments of the process flows described and/or contemplated herein in connection any process flow described herein. Additionally, the system 420 or the user input system 430 is configured to initiate presentation of any of the user interfaces described herein.

The user input system 430 may include any computerized apparatus that can be configured to perform any one or more of the functions of the user input system 430 described and/or contemplated herein. For example, the user 435 may use the user input system 430 to transmit and/or receive information or commands to and from the system 420. In some embodiments, for example, the user input system 430 may include a personal computer system (e.g. a non-mobile or non-portable computing system, or the like), a mobile computing device, a personal digital assistant, a mobile phone, a tablet computing device, a network device, a wearable computing device, a sensor, and/or the like. As illustrated in FIG. 4, in accordance with some embodiments of the present invention, the user input system 430 includes a communication interface 432, a processor 434, a memory 436 having a user application 438 stored therein, and a user interface 439. In such embodiments, the communication interface 432 is operatively and selectively connected to the processor 434, which is operatively and selectively connected to the user interface 439 and the memory 436. In some embodiments, the user 435 may use the user application 438 to execute processes described with respect to the process flow and interfaces described herein. Specifically, the user application 438 executes the process flow described in FIG. 1.

Each communication interface described herein, including the communication interface 432, generally includes hardware, and, in some instances, software, that enables the user input system 430, to transport, send, receive, and/or otherwise communicate information to and/or from the communication interface of one or more other systems on the network 410. For example, the communication interface 432 of the user input system 430 may include a wireless transceiver, modem, server, electrical connection, and/or other electronic device that operatively connects the user input system 430 to another system such as the system 420. The wireless transceiver may include a radio circuit to enable wireless transmission and reception of information. Each processor described herein, including the processor 434, generally includes circuitry for implementing the audio, visual, and/or logic functions of the user input system 430. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 438 of the memory 436 of the user input system 430.

Each memory device described herein, including the memory 436 for storing the user application 438 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 436 includes the user application 438. In some embodiments, the user application 438 includes an interface for communicating with, navigating, controlling, configuring, and/or using the user input system 430. In some embodiments, the user application 438 includes computer-executable program code portions for instructing the processor 434 to perform one or more of the functions of the user application 438 described and/or contemplated herein. In some embodiments, the user application 438 may include and/or use one or more network and/or system communication protocols.

Also shown in FIG. 4 is the user interface 439. In some embodiments, the user interface 439 includes one or more output devices, such as a display and/or speaker, for presenting information to the user 435. In some embodiments, the user interface 439 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 435. In some embodiments, the user interface 439 includes the input and display devices of a mobile device, which are operable to receive and display information.

Also shown in FIG. 4 is a user 435 of the user input system 430. The user input system 430 may be any computing device. The user 435 may be a person who uses the user input system 430 to execute a user application 438. The user application 438 may be an application to communicate with the system 420, perform a transaction, input information onto a user interface presented on the user input system 430, receive and/or transmit information, the like. The user application 438 and/or the system application 428 may incorporate one or more parts of any process flow described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for resolving error cases related to transactions using a research tool that provides a research scenario from a plurality of research scenarios based on information related to an error case for a transaction, the system comprising:
at least one memory;
at least one processor; and
at least one module stored in memory, executable by the at least one processor, and configured for:
presenting a research interface to a user to resolve the error case related to the transaction for which an error occurred during processing of the transaction;
receiving error case information associated with the error case, wherein the error case information may be inputted manually or populated automatically with information captured during processing of the transaction, and wherein the error case information comprises a plurality of inputs about the error;
initiating presentation of the research scenario from the plurality of research scenarios comprising a plurality of resolution information fields configured for receiving resolution information of the error case, wherein the research scenario presented is based on combinations of the plurality of inputs about the error;
receiving resolution information for the error case, wherein the resolution information is inputted into the plurality of resolution information fields from the user; and
generating case notes for resolving the error case based on the error case information and the resolution information received for the error case.

2. The system of claim 1, wherein initiating presentation of the research scenario comprises
determining a scenario number based on the error case information, wherein the scenario number corresponds to the research scenario from the plurality of research scenarios.

3. The system of claim 1, wherein the research scenario further comprises predetermined instructions for researching the error case, wherein the predetermined instructions further comprise research steps for researching and resolving the error case and checkpoints for making sure the use is following the research steps.

4. The system of claim 1, wherein the module stored is further executable by the at least one processor, and configured for:
generating a form from a plurality of forms with at least one of the error case information, the resolution information, or the case notes of the error case for communication with a processing entity from a plurality of processing entities for resolution of the error case, wherein the form and processing entity are selected by the user.

5. The system of claim 4, wherein the module stored is further executable by the at least one processor, and configured for:
transmitting the form to the processing entity for resolution of the error case, wherein resolution of the error case comprises an adjustment of at least one financial account balance.

6. The system of claim 1, wherein the module stored is further executable by the at least one processor, and configured for:
generating a resolution history of each error case resolved by the user after generating the case notes.

7. The system of claim 1, wherein the error case information comprises an input indicating that the error case is a debit case or a credit case, an input indicating that the error case is an internal account or an external account, and an input indicating that adjustment funds has or has not already been applied to an account.

8. The system of claim 7, wherein receiving error case information of the error case comprises calculating the case amount based on a calculated difference between the listed transaction amount and the correct transaction amount.

9. The system of claim 1, wherein the error case information is automatically received from a transaction processing application that comprises information related the error case including at least one of account information, payment information, and transaction information.

10. The system of claim 1, wherein the resolution information comprises at least one of a maker account number, a maker name, a depositor name, a depositor account number, a reversal of charges, a customer initiated case, a government restriction, or an outgoing bank name.

11. A computer program product for resolving error cases related to transactions using a research tool that provides a research scenario from a plurality a research scenarios based on information related to an error case for a transaction, the computer program product comprising at least one non-transitory computer-readable medium having computer-readable program code portions embodied therein, the computer-readable program code portions comprising:
an executable portion configured for presenting a research interface to a user to resolve the error case related to the transaction for which an error occurred during processing of the transaction;
an executable portion configured for receiving error case information associated with the error case, wherein the error case information may be inputted manually or populated automatically with information captured during processing of the transaction, and wherein the error case information comprises a plurality of inputs about the error;
an executable portion configured for initiating presentation of the research scenario from the plurality of research scenarios comprising a plurality of resolution information fields configured for receiving resolution information of the error case, wherein the research scenario presented is based on combinations of the plurality of inputs about the error;
an executable portion configured for receiving resolution information for the error case, wherein the resolution information is inputted into the plurality of resolution information fields from the user; and
an executable portion configured for generating case notes for resolving the error case based on the error case information and the resolution information received for the error case.

12. The computer program product of claim 11, wherein the executable portion configured for initiating presentation of the research scenario comprises:
determining a scenario number based on the error case information, wherein the scenario number corresponds to the research scenario from the plurality of research scenarios.

13. The computer program product of claim 11, wherein the research scenario further comprises predetermined instructions for researching the error case, wherein the predetermined instructions further comprise research steps for researching and resolving the error case and checkpoints for making sure the user is following the research steps.

14. The computer program product of claim 11, wherein the computer-readable program code portions further comprise:
an executable portion configured for generating a form from a plurality of forms with at least one of the error case information, the resolution information, or the case notes of the error case for communication with a processing entity from a plurality of processing entities for resolution of the error case, wherein the form and processing entity are selected by the user.

15. The computer program product of claim 14, wherein the computer-readable program code portions further comprise:
an executable portion configured for transmitting the form to the processing entity for resolution of the error case, wherein resolution of the error case comprises an adjustment of at least one financial account balance.

16. The computer program product of claim 11, wherein the computer-readable program code portions further comprise:
an executable portion configured for generating a resolution history of each error case resolved by the user after generating the case notes.

17. The computer program product of claim 11, wherein the error case information comprises an input indicating that the error case is a debit case or a credit case, an input indicating that the error case is an internal account or an external account, and an input indicating that an adjustment funds has or has not already been applied to an account.

18. The computer program product of claim 11, wherein the executable portion configured for receiving error case information of the error case comprises calculating the case amount based on a calculated difference between the listed transaction amount and the correct transaction amount.

19. The computer program product of claim 11, wherein the error case information is automatically received from a transaction processing application that comprises information related the error case including at least one of account information, payment information, and transaction information.

20. The computer program product of claim 11, wherein the resolution information comprises at least one of a maker account number, a maker name, a depositor name, a depositor account number, a reversal of charges, a customer initiated case, a government restriction, or an outgoing bank name.

21. A method for resolving error cases related to transactions using a research tool that provides a research scenario from a plurality a research scenarios based on information related to an error case for a transaction, the method comprising:
presenting a research interface to a user to resolve the error case related to the transaction for which an error occurred during processing of the transaction;
receiving error case information associated with the error case, wherein the error case information may be inputted manually or populated automatically with information captured during processing of the transaction, and wherein the error case information comprises a plurality of inputs about the error;
initiating presentation of the research scenario from the plurality of research scenarios comprising a plurality of resolution information fields configured for receiving resolution information of the error case, wherein the research scenario presented is based on combinations of the plurality of inputs about the error;
receiving resolution information for the error case, wherein the resolution information is inputted into the plurality of resolution information fields by the user; and
generating case notes for resolving the error case based on the error case information and the resolution information received for the error case.
